(19) United States
(12) Patent Application Publication
(10) Pub. No.: US 2026/0023931 A1
(43) Pub. Date: Jan. 22, 2026

(54) API CONNECTORS

(71) Applicant: AppDirect, Inc., San Francisco, CA (US)

(72) Inventor: Mathew L. Spolin, San Francisco, CA (US)

(21) Appl. No.: 18/775,221

(22) Filed: Jul. 17, 2024

(51) Int. Cl. G06F 40/35; H04L 67/02

(52) U.S. Cl. CPC G06F 40/35; H04L 67/02

(57) ABSTRACT

A method for API connectors includes receiving from a user account a first API request formatted for a source system and comprising an intent, selecting a first action corresponding to the intent, generating a first prompt based on the first action, providing the first prompt to a first large language model (LLM) and receiving a response having a structured description of the intent, using the structured description of the intent to select a second action, generating a second prompt based on the second action, providing the second prompt to a second LLM and receiving a response having a second API request formatted for a destination system, providing the second API request to the destination system, receiving from the destination system a response to the second API request, and providing the response to the second API request to the user account.

### TECHNICAL FIELD

The present disclosure generally relates to application programming interfaces (APIs), and more particularly to connectors between APIs.

### BACKGROUND

Traditional connectors between APIs of different systems are one of the most common and most expensive kinds of software to build. API connectors are prone to failure due to frequent API changes, among other issues. Companies spend fortunes to build libraries that connect APIs but are brittle and difficult to maintain because changes to APIs on either side or service interruptions can cause working code to start inexplicably failing. Connecting APIs involves mapping endpoints and values against one another, but traditional programming is highly sensitive to symbol and formatting matching. Different approaches to reduce the cost of building and running these connectors have been attempted, including monoliths, frameworks, lambdas, etc.

As such, there is a need for API connectors with greater flexibility, robustness, and scalability.

### SUMMARY

Some embodiments of the present disclosure provide a method for API connectors. The method includes receiving from a user account a first API request formatted for a source system, the first API request including an intent, and using the first API request, selecting from a storage a first defined action corresponding to the intent, the first defined action including a first group of parameters that characterize the first defined action and a first natural language description of the first defined action.

The method of some embodiments further includes generating a first prompt from the first group of parameters and the first natural language description, providing the first prompt to a first large language model (LLM), and receiving from the first LLM a response to the first prompt, the response including a structured description of the intent.

The method of some embodiments further includes using the structured description of the intent to select from the storage a second defined action, the second defined action including a second group of parameters that characterize the second defined action and a second natural language description of the second defined action.

The method of some embodiments further includes generating a second prompt including the second plurality of parameters and the second natural language description, providing the second prompt to a second LLM, and receiving from the second LLM a response to the second prompt, the response including a second API request formatted for a destination system.

The method of some embodiments further includes providing the second API request to the destination system, receiving from the destination system a response to the second API request, and providing the response to the second API request to the user account.

Some embodiments of the present disclosure provide a non-transitory computer-readable medium storing a program for API connectors. The program, when executed by a computer, configures the computer to receive from a user account a first API request formatted for a source system, the first API request including an intent, and use the first API request to select from a storage a first defined action corresponding to the intent, the first defined action including a first group of parameters that characterize the first defined action and a first natural language description of the first defined action.

In some embodiments, the executed program further configures the computer to generate a first prompt from the first group of parameters and the first natural language description, provide the first prompt to a first large language model (LLM), and receive, from the first LLM, a response to the first prompt, the response including a structured description of the intent.

In some embodiments, the executed program further configures the computer to use the structured description of the intent to select from the storage a second defined action, the second defined action including a second group of parameters that characterize the second defined action and a second natural language description of the second defined action.

In some embodiments, the executed program further configures the computer to generate a second prompt including the second group of parameters and the second natural language description, provide the second prompt to a second LLM, and receive, from the second LLM, a response to the second prompt, the response including a second API request formatted for a destination system.

In some embodiments, the executed program further configures the computer to provide the second API request to the destination system, receive from the destination system a response to the second API request, and provide the response to the second API request to the user account.

Some embodiments of the present disclosure provide a system for API connectors. The system includes a processor and a non-transitory computer-readable medium storing a set of instructions, which when executed by the processor, configure the processor to receive from a user account a first API request formatted for a source system, the first API request including an intent, and use the first API request to select from a storage a first defined action corresponding to the intent, the first defined action including a first group of parameters that characterize the first defined action and a first natural language description of the first defined action.

In some embodiments, the executed instructions further configure the processor to generate a first prompt from the first group of parameters and the first natural language description, provide the first prompt to a first large language model (LLM), and receive, from the first LLM, a response to the first prompt, the response including a structured description of the intent.

In some embodiments, the executed instructions further configure the processor to use the structured description of the intent to select from the storage a second defined action, the second defined action including a second group of parameters that characterize the second defined action and a second natural language description of the second defined action.

In some embodiments, the executed instructions further configure the processor to generate a second prompt including the second group of parameters and the second natural language description, provide the second prompt to a second LLM, and receive, from the second LLM, a response to the second prompt, the response including a second API request formatted for a destination system.

In some embodiments, the executed instructions further configure the processor to provide the second API request to the destination system, receive from the destination system a response to the second API request, and provide the response to the second API request to the user account.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement API connectors, according to some embodiments.

FIG. 2A is a block diagram illustrating details of a system for API connectors, according to some embodiments.

FIG. 2B is a block diagram illustrating details of a system for API connectors, according to some embodiments.

FIGS. 3A and FIG. 3B show a system for API connectors, according to some embodiments.

FIG. 4 is a flowchart illustrating a process for an API connector data flow, according to some embodiments.

FIGS. 5A and FIG. 5B are a flowchart illustrating a process for an API connector data flow, according to some embodiments.

FIG. 6 is a block diagram illustrating an exemplary computer system with which aspects of the subject technology can be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

All references cited anywhere in this specification, including the Background and Detailed Description sections, are incorporated by reference as if each had been individually incorporated.

The term “Application programming interface” or API as used herein refers, according to some embodiments, to a set of protocols, definitions, and functions that enable different software applications to communicate and interact with each other. APIs define how software components should interact, allowing developers to build applications that can leverage the functionality or data of external applications or services. APIs enable the integration and interoperability of different systems and platforms, by providing a standardized way for applications to access and utilize each other’s capabilities.

The term “API connectors” as used herein refers, according to some embodiments, to software components that facilitate communication and data exchange between different software applications by interfacing with their respective APIs. API connectors act as an intermediary between external source systems and destination systems, translating the rules and protocols defined by an API into actionable functionality, allowing the applications to integrate and share data. The term “connectors” and “integrations” are here used equivalently to “API connectors.”

Embodiments of the present disclosure address the above identified problems by providing systems for API connectors, and more specifically, systems for AI-based connectors. Embodiments of API connectors may provide a modular, scalable, and secure architecture. Some embodiments comprise core components that interact through well-defined interfaces, enabling integration to existing systems and expansion to future systems.

### Real-World Use Cases

E-Commerce and Supply Chain Integration: Some embodiments automate the syncing of inventory levels between an e-commerce platform and a supply chain management system. When a product is sold or restocked, the LLM agent can trigger the necessary updates across both systems.

Customer Onboarding in Financial Services: Some embodiments integrate CRM, credit scoring, and account creation APIs to streamline a customer onboarding process. Upon receiving a new application, the LLM agent could initiate a credit check and, if approved, automatically set up a new account.

Event-Driven Marketing Campaigns: Some embodiments provide link marketing automation platforms with analytics tools. When a user action triggers a certain condition (e.g., shopping cart abandonment), the LLM agent may initiate a re-targeting email campaign.

Health Data Aggregation: Some embodiments sync patient data from electronic health record systems to analytics platforms for real-time monitoring and decision-making.

IT Operations and Monitoring: Some embodiments integrate incident management systems with cloud monitoring tools. If an anomaly is detected, the LLM agent may automatically create an incident ticket and notify the operations team.

### Multi-platform Content Publishing

Some embodiments automatically publish content across various platforms like blogs, social media, and newsletters. Once the primary content is ready, the LLM agent may format and distribute it to different channels.

### Employee Onboarding and Offboarding

Some embodiments tie together HR platforms, email systems, and access control systems. When a new employee is onboarded, the LLM agent may activate accounts, assign roles, and grant necessary permissions. Conversely, it can revoke access during offboarding.

These use cases exemplify the system’s versatility and its capability to drive efficiencies by intelligently connecting disparate APIs and automating workflows across a variety of industries.

In some embodiments, AI-based connectors may include, but are not limited to, Large Language Model (LLM)-based connectors. Some embodiments below are described with reference to LLM-based connectors, but other embodiments may use convolutional neural (CNN) network systems, other types of neural network (NN) systems, artificial intelligence (AI) systems, machine learning (ML) systems, and the like. Such systems may intelligently map and connect disparate APIs used for applications including, but not limited to, commerce, provisioning, and information, and may substantially reduce the cost and complexity of building and maintaining these integrations.

According to some embodiments, the system uses API definitions that describe type, authentication, and a series of endpoints in a data structure. The data structure may be, as a non-limiting example, a JavaScript Object Notation (JSON) data structure. The descriptive text associated with each definition may aid an LLM in connecting endpoints together to create actions. Each endpoint may support different types of actions.

### Actions

In some embodiments, actions are defined using a unique symbol, an intent (described in some embodiments as a prompt to an LLM), and a reference to the kinds of endpoints that the action requires to operate. Some actions may be immediate and are invoked to complete a transaction, like posting a payment, or extending a contract term. Some actions may encompass long running, polling type behavior, like waiting for events from an external system.

### Directory

According to some embodiments, multiple APIs that are available to connect are presented to a user in a catalog or directory, with identifiers (e.g., labels, logos, and the like) for each external system clearly visible. An external system may be available as a source system, a destination system, or both. It may be possible to browse the directory by the actions that are supported. Actions may be designed as a higher-level encapsulation of an activity involving orchestrating several APIs together.

### Invoking Actions

In some embodiments, when an action is invoked, the endpoints, their enclosing APIs, and the intent are passed to an agent in the form of a prompt, along with other contextual information needed for processing. The agent, using authentication methods from the API definition and/or credentials supplied with the action, may interpret the action and make an API request from the source system. Internally, this may be accomplished, as a non-limiting example, by a prompt to an LLM that generates the API call which is executed traditionally and captures the result. The API call may be, as a non-limiting example, generating a client-for-URL (cURL) command and capturing the result.

In some embodiments, there may be errors in executing the action. Examples of such errors include but are not limited to the LLM failing to construct the query correctly, network problems, and the API definitions being incorrect or out of date. In the event of an error, the agent may log and evaluate the error and, if so configured, try again.

In some embodiments, even if the system is tuned properly, the LLM may still occasionally fail to construct the query, so the system is further configured to detect network problems and other issues that can result from API definitions being incorrect or out of date.

In some embodiments, if the request is successful, the agent may transform the necessary parameters to intelligently map between the source and destination systems, using context from the action prompt as necessary.

In some embodiments, using credentials supplied with the action and the authentication method from the API definition, the agent may create and transmit the parameters to the destination system. Internally this may be accomplished, as a non-limiting example, by a separate prompt that creates the outbound API request.

In some embodiments, the agent action and associated parameters and activity may be written to a system log.

### Security Layers

Some embodiments use various protocols and systems for multiple layers of security. These include, in some embodiments, some or all of:

Transport Layer Security (TLS) for encrypted data transmission;

Firewall and Intrusion Detection System (IDS) for network security; and

Strict access controls and Multi-factor Authentication (MFA) for system access.

Such an architecture may provide robust, extensible, and secure solutions for API connectivity.

### Security Measures

Some embodiments provide various security measures to build a connector system that is not only efficient but also robust against various security vulnerabilities, including prompt injection threats. These measures include, but are not limited to:

Credentials Management: Some embodiments provide a secure credentials vault for storing and retrieving API credentials, eliminating the risk of hard-coded or exposed keys. Multi-factor authentication (MFA) and role-based access control (RBAC) may be utilized to ensure that only authorized personnel can access sensitive information.

Secure Communication: Some embodiments make all API calls over HTTPS to ensure secure data transmission. Data encryption may be used both at rest and in transit to further enhance security.

Prompt Injection Prevention: To mitigate the risk of prompt injection, in some embodiments all prompts fed to the LLM agent are validated against a pre-defined schema for permissible content. The system may utilize prepared statements or parameterized queries, effectively neutralizing any attempts to exploit the LLM prompt mechanism. Strict input validation may be applied to all data fields that interact with the LLM, blocking unrecognized or malicious commands.

### Auditing and Monitoring

In some embodiments, security logs are maintained to keep track of all operations, changes, and access. Alerts may be configured for suspicious activities. The system may comply with auditing standards to provide a detailed account of security events.

Secure Software Development Lifecycle (SDLC). In some embodiments, security may be integrated into every phase of the software development process. Code reviews may include security audits, and penetration testing may be performed at regular intervals.

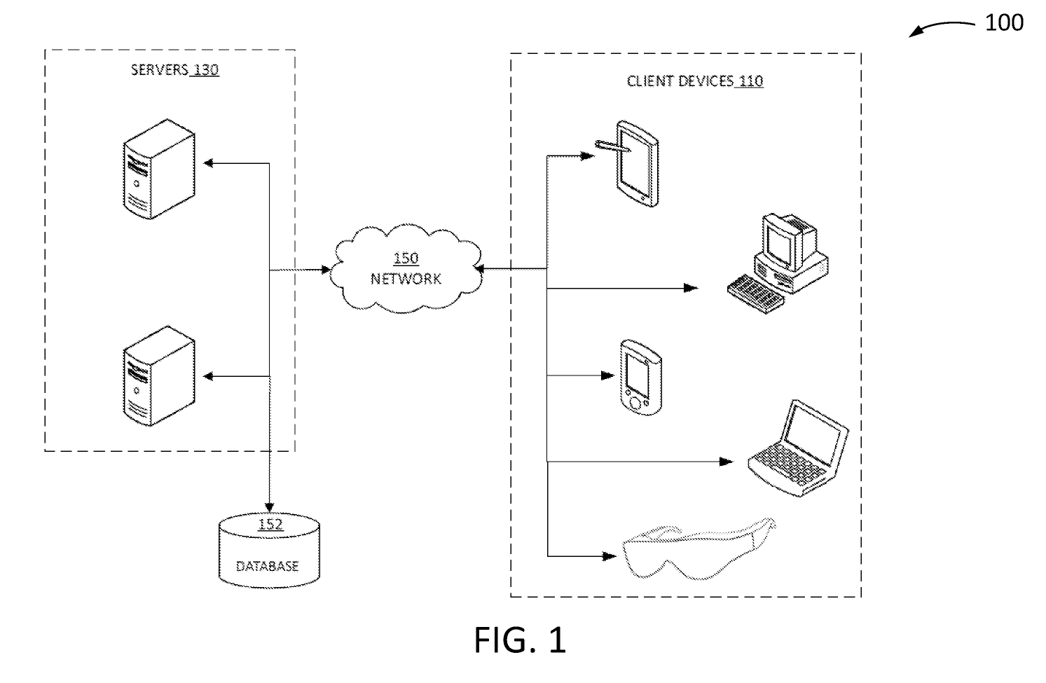

FIG. 1 illustrates a network architecture 100 used to implement API connectors, according to some embodiments. The network architecture 100 may include one or more client devices 110 and servers 130, communicatively coupled via a network 150 with each other and to at least one database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

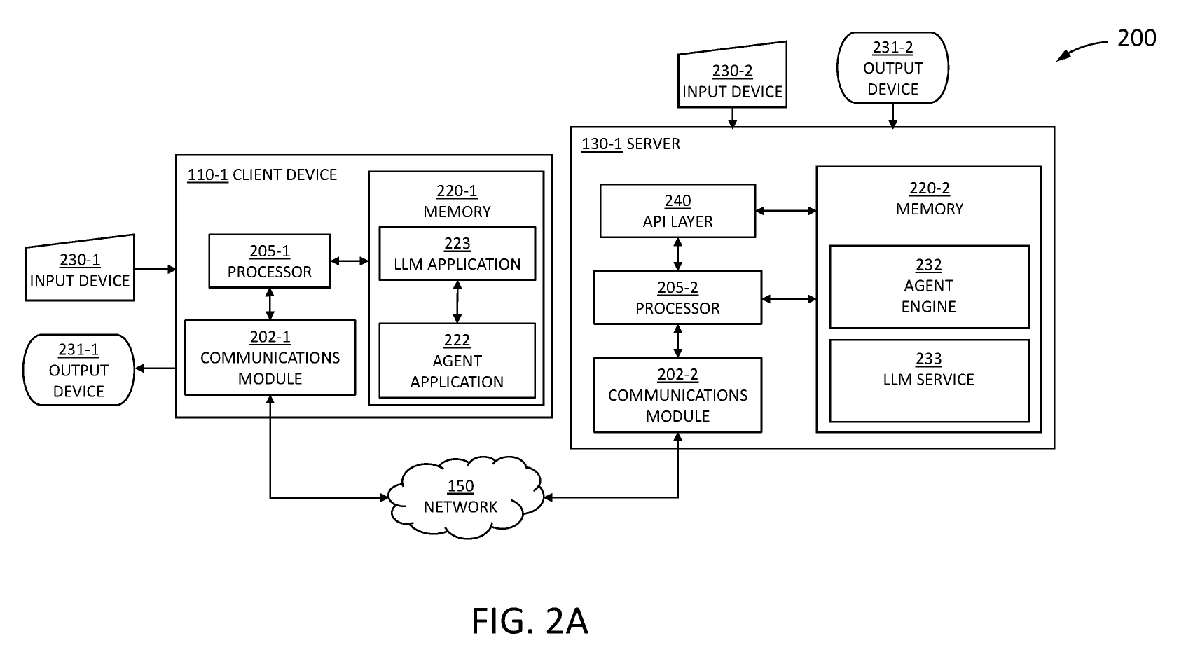

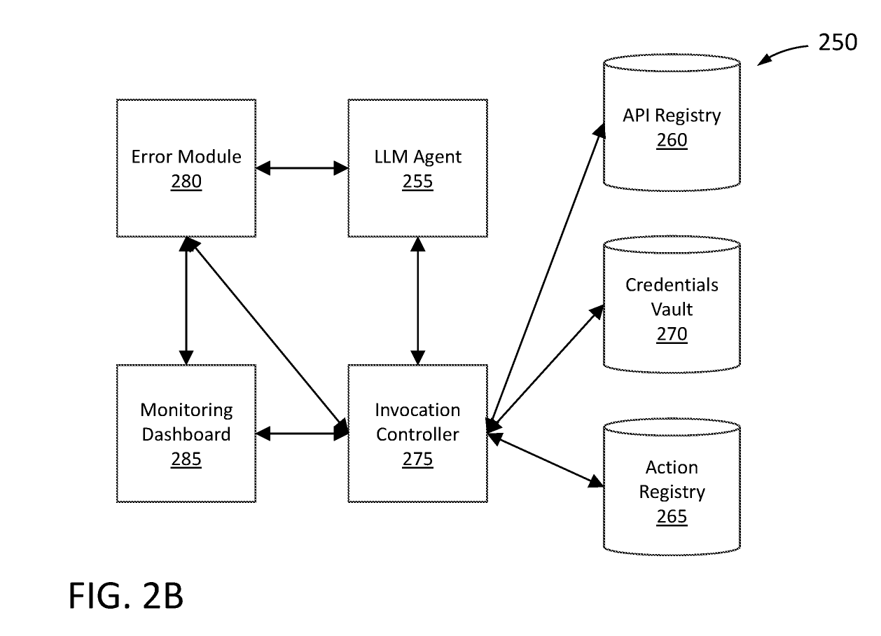

FIG. 2A is a block diagram illustrating details of a system 200 for API connectors, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 231-1 and output device 231-2, respectively (hereinafter, collectively referred to as “output devices 231”). The output devices 231 may include a screen, a display (e.g., a same touchscreen display used as an input device), a speaker, an alarm, and the like. A user may interact with client device 110-1 and/or server 130-1 via the input devices 230 and the output devices 231.

Memory 220-1 may further include an agent application 222, configured to execute on client device 110-1 and couple with input device 230-1 and output device 231-1. The agent application 222 may be downloaded by the user from server 130-1, and/or may be hosted by server 130-1. The agent application 222 may include specific instructions which, when executed by processor 205-1, cause operations to be performed consistent with embodiments of the present disclosure. In some embodiments, the agent application 222 runs on an operating system (OS) installed in client device 110-1. In some embodiments, agent application 222 may run within a web browser. In some embodiments, the processor 205-1 is configured to control a graphical user interface (GUI) (e.g., spanning at least a portion of input devices 230 and output devices 231) for the user of client device 110-1 to access the server 130-1.

In some embodiments, memory 220-2 includes an agent engine 232. The agent engine 232 may be configured to perform methods and operations consistent with embodiments of the present disclosure. The agent engine 232 may share or provide features and resources with the client device 110-1, including data, libraries, and/or applications retrieved with agent engine 232 (e.g., agent application 222). The user may access the agent engine 232 through the agent application 222. The agent application 222 may be installed in client device 110-1 by the agent engine 232 and/or may execute scripts, routines, programs, applications, and the like provided by the agent engine 232.

Memory 220-1 may further include an LLM application 223, configured to execute in client device 110-1. The LLM application 223 may communicate with agent application 222 and/or with LLM service 233 in memory 220-2 to provide or share data. In some embodiments, agent application 222 and/or the LLM application 223 may communicate with the agent engine 232 and/or the LLM service 233 through API layer 240.

FIG. 2B is a block diagram illustrating details of a system 250 for API connectors, according to some embodiments. In some embodiments, the system includes 250 core components that interact through explicitly defined interfaces, enabling integration and future expansions. Core components may include some or all of the following, according to various embodiments:

LLM Agent 255: A core engine responsible for interpreting actions and generating API calls. The LLM agent 255 may interact with API Registry 260 to understand the context of API requests and execute operations such as function calls.

API Registry 260: A secure database that holds JSON-formatted API definitions, including authentication methods and endpoint details.

Action Registry 265: A database that contains predefined actions with associated intents, endpoints, and other metadata.

Credentials Vault 270: A secure storage facility for API credentials, integrated with strong encryption and access controls.

Invocation Controller 275: A module that manages the invoking of actions by coordinating with the LLM Agent 255 and other system components.

Error Module 280: A module for error handling and logging, that records system activities and manages error scenarios, including retries and alerting.

Monitoring Dashboard 285: A user-interface that provides real-time monitoring capabilities and system health checks.

In some embodiments, some or all of the above-described core components may be modules executing on a client device (e.g., client device 110-1) or a server (e.g., server 130-1). Modules may be fully or partially implemented as agent application 222, LLM application 223, LLM service 233, agent engine 232, or any combination thereof.

In some embodiments, system 250 receives an API call associated with a first API service and uses that received API call to generate a new API call to a second API service. In other embodiments, the system 250 initiates an API call to the first API service and processes the result to make the new call to the second API service.

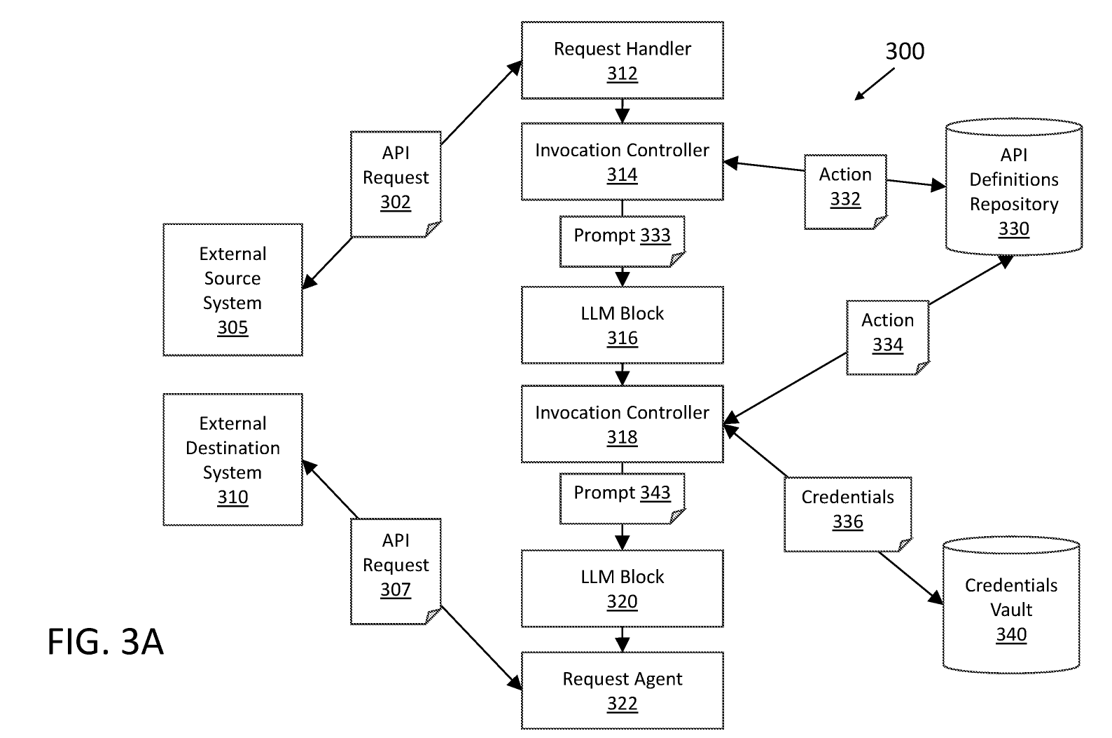

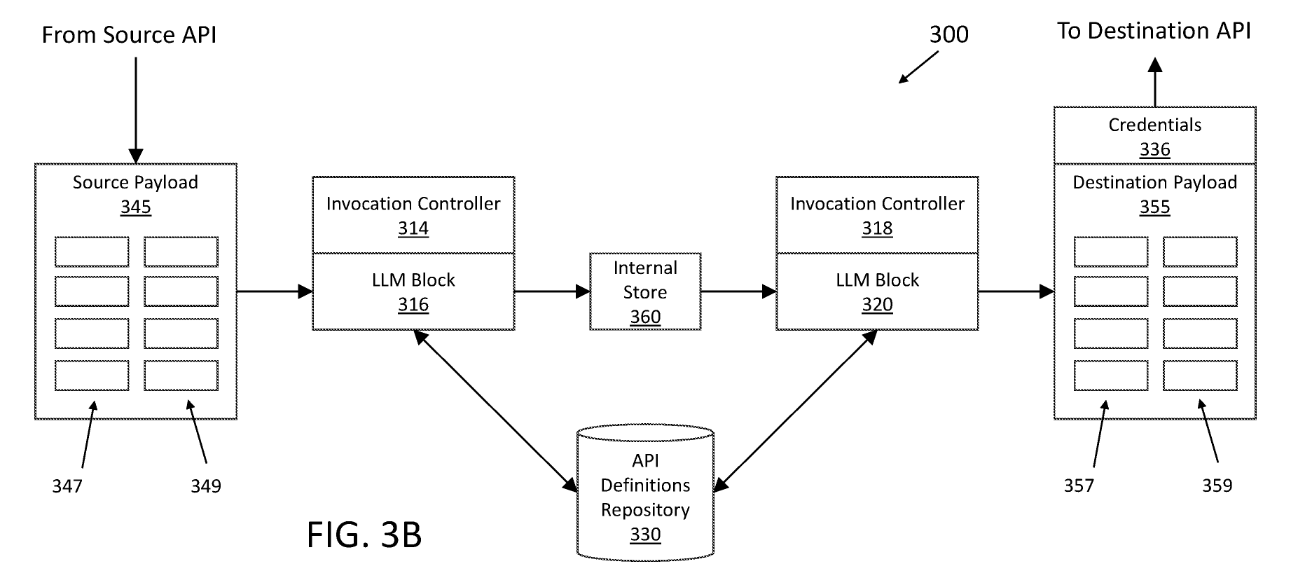

FIGS. 3A and FIG. 3B show a system 300 for API connectors, according to some embodiments. As shown in FIG. 3A, the system 300 receives an API request 302 originating from an external source system 305, processes the API request to generate a new API request 307 to provide to an external destination system 310, and provides the result of API request 307 to originating external source system 305.

Alternatively, the API request 302 may be generated by system 300, intended to access an API associated with the external source system 305. The system 300 then processes the result of API request 302, to generate API request 307 for external destination system 310.

In some embodiments, the initial API request (e.g., API request 302) originates from any source, including but not limited to a server, a client, a system, a user (e.g., a person), an entity (e.g., a business, an organization, and the like), and a user account associated with a person or an entity.

In some embodiments, the system 300 performs a first API request 302 to the external source system 305, processes the response, and uses that response to make a second API request 307 to the external destination system 310.

In this example, the system 300 includes a request handler 312, a first invocation controller 314, a first LLM block 316, a second invocation controller 318, a second LLM block 320, and a request agent 322. In other embodiments, the system 300 may only include a single invocation controller and/or a single LLM block. In some embodiments, the invocation controllers 314 and 318 may be wrappers for the LLM blocks 316 and 320, to enable the LLMs to externally call APIs and receive data from them.

Request handler 312 receives the API request 302 from the external source system 305 and passes it to the first invocation controller 314. Request handler 312 may perform processing on the API request 302 prior to passing it to the first invocation controller 314. The first invocation controller 314 consults an API definitions repository 330 and determines what corresponding action 332 to perform. The action 332 may be defined by parameters having values, and a description (e.g., a natural language description) of what operations the action 332 performs. The first invocation controller then constructs a prompt 333 for the LLM block 316, based on the definition of the action 332 (e.g., the parameters, description, etc.).

The LLM block 316 creates an output (not shown) in response to the prompt 333 from the invocation controller 314. The output may be in a structured intermediate format (e.g., a JSON data structure) and represents a processed event.

The output from the LLM block 316 is passed to the second invocation controller 318, which interprets the processed event, and consults the API definitions repository 330 to determine what corresponding action 334 to perform. The action 334 may be defined by parameters having values, and a description of what operations the action 334 performs.

The second invocation controller 318 may also retrieve authentication credentials 336 (e.g., corresponding with external destination system 310) from a credentials vault 340. The second invocation controller 318 then constructs a prompt 343 for the LLM block 320, based on the authentication credentials 336 and the definition of the action 334 (e.g., the parameters, description, etc.).

The output from the LLM block 320 (not shown) is passed to the request agent 322, which generates the API request 307 to the external destination system 310. The API call may be authenticated and secure, using the authentication credentials from the credentials vault 340.

In some embodiments, the external destination system 310 generates an output (not shown) in response to the API request 307 and provides the response to the originator of the initial API request 302.

FIG. 3B shows additional details of the system 300 described above in FIG. 3A. Action 332 may include a source payload 345, which includes source parameters 347 and corresponding source values 349, that are consumed by the LLM block 316. Action 334 may include a destination payload 355, which includes destination parameters 357 and corresponding destination values 359, that are consumed by the LLM block 320.

As noted above, the output from the LLM block 316 may be in a structured intermediate format (e.g., a JSON data structure) and represents a processed event. The output from the LLM block 316 may be stored (e.g., by the invocation controller 314) in an internal store 360. The output may then be retrieved from the internal store 360 (e.g., by the invocation controller 318) and provided to the LLM block 320.

### Data Flow

Some embodiments provide a data flow comprising a number of operations. The operations include initialization, action invocation, API call generation, execution, response handling, and completion, according to some embodiments. In some embodiments, the system makes intermediate API calls to construct the final API call to the destination system.

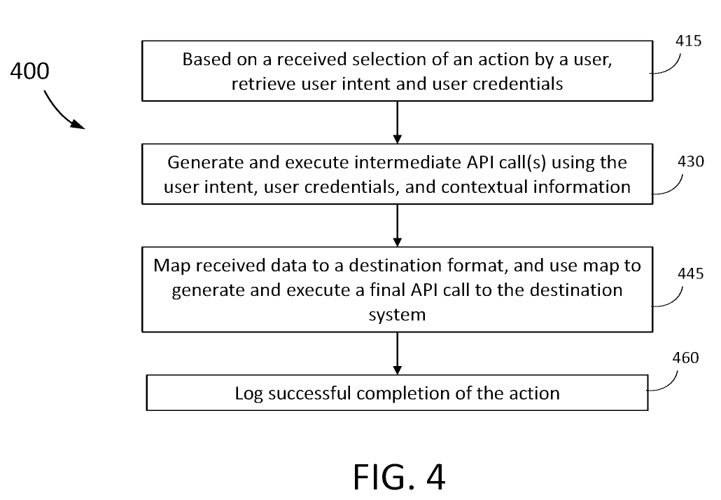

FIG. 4 is a flowchart illustrating a process 400 for an API connector data flow, according to some embodiments. The process 400 may be performed by a client device (e.g., client device 110-1, etc.) and/or a client server (e.g., server 130-1, etc.). In some embodiments, one or more operations in process 400 may be performed by a processor circuit (e.g., processors 205, etc.) executing instructions stored in a memory circuit (e.g., memories 220, etc.) of a system (e.g., system 200, system 300, etc.) as disclosed herein. For example, operations in process 400 may be performed by any of agent application 222, LLM application 223, agent engine 232, LLM service 233, or some combination thereof. Moreover, in some embodiments, a process consistent with this disclosure may include at least operations in process 400 performed in a different order, simultaneously, quasi-simultaneously, or overlapping in time. The process 400 is here described with reference to non-limiting examples of system 200, system 250, and system 300 which are described above.

In some embodiments, one or more operations of process 400 are performed by an LLM agent (e.g., LLM agent 255). The LLM agent may have multiple components including some or all of LLM blocks (e.g., LLM blocks 316 and 320), invocation controllers (e.g., invocation controller 318), and an internal storage (e.g., internal store 360). In some embodiments, one or more operations of process 400 are performed by an invocation controller (e.g., invocation controller 275, invocation controller 314, invocation controller 318, etc.).

At 415, the process 400 receives a selection of an action (e.g., action 332) by a user. In some embodiments, a corresponding user intent (e.g., the action definition, including parameters 347 and values 349) and corresponding user credentials are fetched from API definitions repository 330 and credentials vault 340, respectively.

At 430, the process 400 generates and executes intermediate API calls (e.g., API request 302). In some embodiments, the process 400 uses the user intent, credentials, and other contextual information to generate the API call. In some embodiments, the process 400 consults an API registry (e.g., API Registry 260, API definitions repository 330, etc.) and a credentials vault (e.g., credentials vault 270, credentials vault 340, etc.) to understand the API’s structure and authentication methods to thereby generate the API calls. Responses to the executed API calls may be logged by an error module (e.g., error module 280).

At 445, the process 400 maps received data to a destination format and uses that mapping to generate and execute a final API call to the destination system (e.g., external destination system 310). The mapping may be stored and/or retrieved from an internal store (e.g., internal store 360).

At 460, the process 400 logs the successful completion of the action and any pertinent data. In some embodiments, operation 460 is performed by an error module (e.g., error module 280).

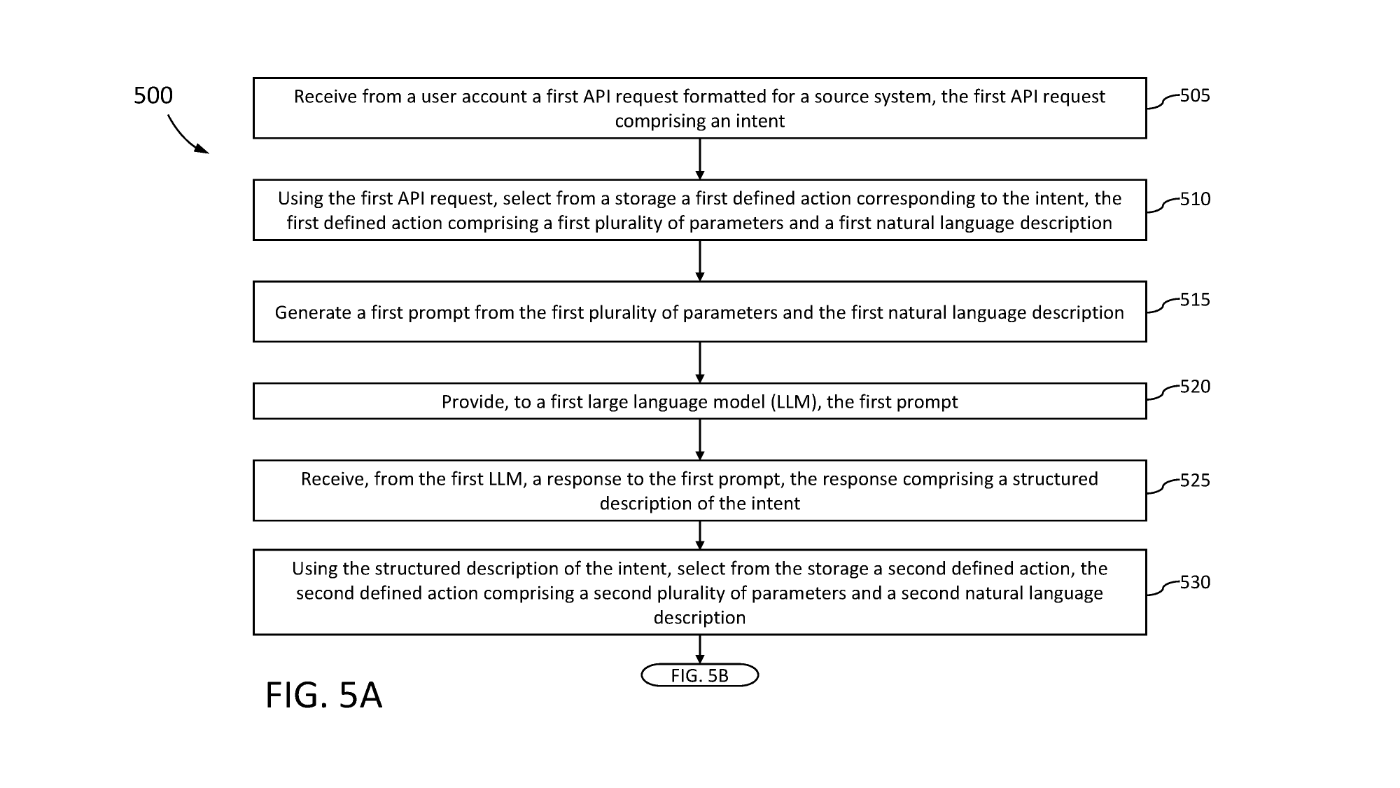

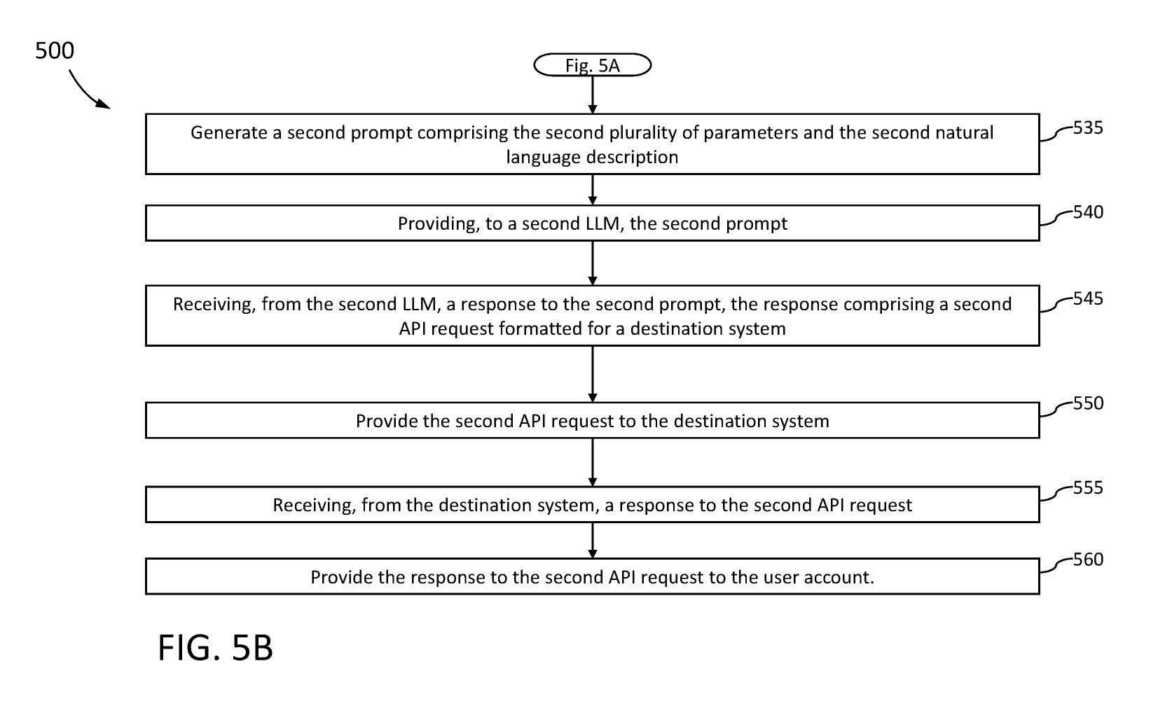

FIGS. 5A and FIG. 5B are a flowchart illustrating a process 500 for an API connector data flow, according to some embodiments. The process 500 may be performed by a client device (e.g., client device 110-1, etc.) and/or a client server (e.g., server 130-1, etc.). In some embodiments, one or more operations in process 500 may be performed by a processor circuit (e.g., processors 205, etc.) executing instructions stored in a memory circuit (e.g., memories 220, etc.) of a system (e.g., system 200, system 300, etc.) as disclosed herein. For example, operations in process 500 may be performed by any of agent application 222, LLM application 223, agent engine 232, LLM service 233, or some combination thereof. Moreover, in some embodiments, a process consistent with this disclosure may include at least operations in process 500 performed in a different order, simultaneously, quasi-simultaneously, or overlapping in time. The process 500 is here described with reference to non-limiting examples of system 200, system 250, and system 300, which are described above.

In some embodiments, one or more operations of process 500 are performed by an LLM agent (e.g., LLM agent 255). The LLM agent may have multiple components including some or all of LLM blocks (e.g., LLM blocks 316 and 320), invocation controller (e.g., invocation controller 318), and an internal storage (e.g., internal store 360). In some embodiments, one or more operations of process 500 are performed by an invocation controller (e.g., invocation controller 275, invocation controller 314, invocation controller 318, etc.).

At 505, the process 500 receives from a user account a first API request formatted for a source system, the first API request comprising an intent.

At 510, the process 500 uses the first API request to select from a storage a first defined action corresponding to the intent, the first defined action comprising a first plurality of parameters that characterize the first defined action and a first natural language description of the first defined action. In some embodiments, the user account selects the first defined action from a directory.

In some embodiments, the first API request includes a first plurality of endpoints, and the process 500 identifies at least one endpoint from the first API request. Selecting the first defined action is based on the at least one identified endpoint. An endpoint may be a Uniform Resource Locator (URL).

At 515, the process 500 generates a first prompt from the first plurality of parameters and the first natural language description. At 520, the process 500 provides, to a first large language model (LLM), the first prompt. At 525, the process 500 receives from the first LLM a response to the first prompt, the response comprising a structured description of the intent. The structured description of the intent may be stored as a JavaScript Object Notation (JSON) data structure.

At 530, the process 500 uses the structured description of the intent to select from the storage a second defined action, the second defined action comprising a second plurality of parameters that characterize the second defined action and a second natural language description of the second defined action.

At 535, the process 500 generates a second prompt comprising the second plurality of parameters and the second natural language description.

At 540, the process 500 provides, to a second LLM, the second prompt. In some embodiments, the second LLM may be the first LLM.

In some embodiments, the process 500 uses the structured description of the intent to also retrieve from a secure storage an authentication credential associated with the destination system. The second prompt to the second LLM further includes the authentication credential.

At 545, the process 500 receives from the second LLM a response to the second prompt, the response comprising a second API request formatted for a destination system. If the authentication credential was used to generate the second prompt, then the second API request includes the authentication credential.

In some embodiments, the second API request includes a second plurality of endpoints, and selecting the second defined action includes using the structured description of the intent to generate a mapping between the first plurality of endpoints to the second plurality of endpoints.

At 550, the process 500 provides the second API request to the destination system. At 555, the process 500 receives, from the destination system, a response to the second API request. At 560, the process 500 provides the response to the second API request to the user account.

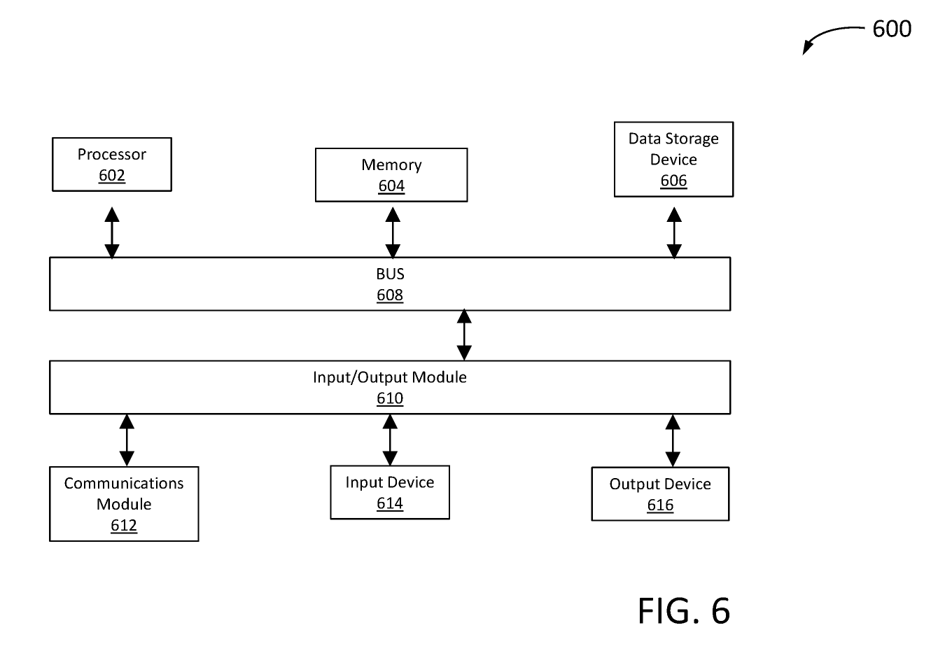

FIG. 6 is a block diagram illustrating an exemplary computer system 600 with which aspects of the subject technology can be implemented. In certain aspects, the computer system 600 may be implemented using hardware or a combination of software and hardware, either in a dedicated server, integrated into another entity, or distributed across multiple entities. As a non-limiting example, the computer system 600 may be one or more of the servers 130 and/or the client devices 110.

Computer system 600 includes a bus 608 or other communication mechanism for communicating information, and a processor 602 coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, i.e., one or more modules of computer program instructions encoded on a computer-readable medium for execution by, or to control the operation of, the computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. The input/output module 610 can be any input/output module. Exemplary input/output modules 610 include data ports such as USB ports. The input/output module 610 is configured to connect to a communications module 612. Exemplary communications modules 612 include networking interface cards, such as Ethernet cards and modems. In certain aspects, the input/output module 610 is configured to connect to a plurality of devices, such as an input device 614 and/or an output device 616. Exemplary input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 616 include display devices such as an LCD (liquid crystal display) monitor, for displaying information to the user.

According to one aspect of the present disclosure, the above-described systems 200, 250, and 300 can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in the main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires that comprise bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 600 reads application data and provides an application, information may be read from the application data and stored in a memory device, such as the memory 604. Additionally, data from the memory 604 servers accessed via a network, the bus 608, or the data storage 606 may be read and loaded into the memory 604. Although data is described as being found in the memory 604, it will be understood that data does not have to be stored in the memory 604 and may be stored in other memory accessible to the processor 602 or distributed among several media, such as the data storage 606.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. §112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A method for API connectors, comprising:
receiving from a user account a first API request formatted for a source system, the first API request comprising an intent;
using the first API request, selecting from a storage a first defined action corresponding to the intent, the first defined action comprising a first plurality of parameters that characterize the first defined action and a first natural language description of the first defined action;
generating a first prompt from the first plurality of parameters and the first natural language description;
providing, to a first large language model (LLM), the first prompt;
receiving, from the first LLM, a response to the first prompt, the response comprising a structured description of the intent;
using the structured description of the intent, selecting from the storage a second defined action, the second defined action comprising a second plurality of parameters that characterize the second defined action and a second natural language description of the second defined action;
generating a second prompt comprising the second plurality of parameters and the second natural language description;
providing, to a second LLM, the second prompt;
receiving, from the second LLM, a response to the second prompt, the response comprising a second API request formatted for a destination system;
providing the second API request to the destination system;
receiving, from the destination system, a response to the second API request; and
providing the response to the second API request to the user account.

2. The method of claim 1, further comprising:
using the structured description of the intent, retrieving from a secure storage an authentication credential associated with the destination system,
wherein the second prompt further comprises the authentication credential.

3. The method of claim 1, wherein the second LLM is the first LLM.

4. The method of claim 1, wherein the structured description of the intent is stored in the storage as a JavaScript Object Notation (JSON) data structure.

5. The method of claim 1, wherein the user account selects the first defined action from a directory.

6. The method of claim 1, wherein the first API request comprises a first plurality of endpoints, the method further comprising identifying at least one endpoint from the first API request, wherein selecting the first defined action is based on the at least one identified endpoint.

7. The method of claim 6, wherein the second API request comprises a second plurality of endpoints, and selecting the second defined action comprises using the structured description of the intent to generate a mapping between the first plurality of endpoints to the second plurality of endpoints.

8. The method of claim 6, wherein the at least one endpoint is a Uniform Resource Locator (URL).

9. A non-transitory computer-readable medium storing a program for API connectors, which when executed by a computer, configures the computer to:
receive from a user account a first API request formatted for a source system, the first API request comprising an intent;
using the first API request, select from a storage a first defined action corresponding to the intent, the first defined action comprising a first plurality of parameters that characterize the first defined action and a first natural language description of the first defined action;
generate a first prompt from the first plurality of parameters and the first natural language description;
provide, to a first large language model (LLM), the first prompt;
receive, from the first LLM, a response to the first prompt, the response comprising a structured description of the intent;
using the structured description of the intent, select from the storage a second defined action, the second defined action comprising a second plurality of parameters that characterize the second defined action and a second natural language description of the second defined action;
generate a second prompt comprising the second plurality of parameters and the second natural language description;
provide, to a second LLM, the second prompt;
receive, from the second LLM, a response to the second prompt, the response comprising a second API request formatted for a destination system;
provide the second API request to the destination system;
receive, from the destination system, a response to the second API request; and
provide the response to the second API request to the user account.

10. The non-transitory computer-readable medium of claim 9, wherein the program, when executed by the computer, further configures the computer to:
using the structured description of the intent, retrieve from a secure storage an authentication credential associated with the destination system,
wherein the second prompt further comprises the authentication credential.

11. The non-transitory computer-readable medium of claim 9, wherein the second LLM is the first LLM.

12. The non-transitory computer-readable medium of claim 9, wherein the user account selects the first defined action from a directory.

13. The non-transitory computer-readable medium of claim 9, wherein the first API request comprises a first plurality of endpoints, and the program, when executed by the computer, further configures the computer to identify at least one endpoint from the first API request, wherein selecting the first defined action is based on the at least one identified endpoint.

14. The non-transitory computer-readable medium of claim 13, wherein the second API request comprises a second plurality of endpoints, and selecting the second defined action comprises using the structured description of the intent to generate a mapping between the first plurality of endpoints to the second plurality of endpoints.

15. A system for API connectors, comprising:
at least one processor; and
a non-transitory computer-readable medium storing a set of instructions, which when executed by the processor, configure the system to:
receive from a user account a first API request formatted for a source system, the first API request comprising an intent;
using the first API request, select from a storage a first defined action corresponding to the intent, the first defined action comprising a first plurality of parameters that characterize the first defined action and a first natural language description of the first defined action;
generate a first prompt from the first plurality of parameters and the first natural language description;
provide, to a first large language model (LLM), the first prompt;
receive, from the first LLM, a response to the first prompt, the response comprising a structured description of the intent;
using the structured description of the intent, select from the storage a second defined action, the second defined action comprising a second plurality of parameters that characterize the second defined action and a second natural language description of the second defined action;
generate a second prompt comprising the second plurality of parameters and the second natural language description;
provide, to a second LLM, the second prompt;
receive, from the second LLM, a response to the second prompt, the response comprising a second API request formatted for a destination system;
provide the second API request to the destination system;
receive, from the destination system, a response to the second API request; and
provide the response to the second API request to the user account.

16. The system of claim 15, wherein the instructions, when executed by the processor, further configure the system to:
using the structured description of the intent, retrieve from a secure storage an authentication credential associated with the destination system,
wherein the second prompt further comprises the authentication credential.

17. The system of claim 15, wherein the second LLM is the first LLM.

18. The system of claim 15, wherein the user account selects the first defined action from a directory.

19. The system of claim 15, wherein the first API request comprises a first plurality of endpoints, and the instructions, when executed by the processor, further configure the system to identify at least one endpoint from the first API request, wherein selecting the first defined action is based on the at least one identified endpoint.

20. The system of claim 19, wherein the second API request comprises a second plurality of endpoints, and selecting the second defined action comprises using the structured description of the intent to generate a mapping between the first plurality of endpoints to the second plurality of endpoints.
